(19) United States
(12) Patent Application Publication
(10) Pub. No.: US 2021/0114854 A1
(43) Pub. Date: Apr. 22, 2021

(54) Automated Guided Vehicle Configured for Driverless, Autonomously Acting Operation

(71) Applicant: Robert Bosch GmbH, Stuttgart (DE)

(72) Inventors: Frank Roethling, Stuttgart (DE); Johannes Schild, Abstatt (DE); Markus Brodt, Stuttgart (DE)

(21) Appl. No.: 17/074,865

(22) Filed: Oct. 20, 2020

(30) Foreign Application Priority Data
Oct. 21, 2019 (DE) 10 2019 216 181.2

(51) Int. Cl. B66F 9/06; B66F 9/12; B66F 17/00; G05D 1/02

(52) U.S. Cl. CPC B66F 9/063; B66F 9/127; G05D 2201/0216; G05D 1/0223; B66F 17/006

(57) ABSTRACT

An automated guided vehicle configured for driverless, autonomously acting operation for a load to be transported includes a control system configured to control and to steer the automated guided vehicle, an evaluation unit configured to generate a signal for stopping the automated guided vehicle, and a detector device configured to detect an arrangement of the load and/or of a lifting platform. The detector device is connected to the control system. The automated guided vehicle is stopped automatically when the detected arrangement of the load deviates from a predefined arrangement of the load and/or as a result of an expected lowering of the lifting platform.

This application claims priority under 35 U.S.C. § 119 to patent application no. DE 10 2019 216 181.2, filed on Oct. 21, 2019 in Germany, the disclosure of which is incorporated herein by reference in its entirety.

The disclosure relates to an automated guided vehicle (AGV) configured for driverless, autonomously acting operation for a load which is to be transported. In particular, the disclosure is applied in a robot vehicle for transporting loads. Lifting automated guided vehicles and non-stacking lifting trucks as well as corresponding combinations are also included.

### BACKGROUND

As automation technology has progressed, the handling of loads has assumed increasing importance.

In autonomous transportation, the load can be protected against slipping or even against loss during transportation by mechanical clamping or additional securing or housing measures. When the transportation process is interrupted (for example due to a power failure) it is possible, however, for the (electronically stored) information about the loading state of the AGV, in particular of a lifting platform assigned to the AGV, to be lost, as a result of which it is necessary to abort the transportation process and/or perform complex resetting to an initial state.

### SUMMARY

Taking this as a basis, the object of the disclosure is to provide an automated guided vehicle which is configured for driverless, autonomously acting operation for a load to be transported, which vehicle alleviates or even avoids the abovementioned disadvantages. In particular, clamping of the load or additional securing measures or housing measures are to be dispensed with and automatic resumption of the transportation process after an interruption of the transportation process (e.g. as a result of power failure) is to be achieved.

These objects are achieved with an automated guided vehicle according as disclosed herein. Further refinements of the disclosure are specified in the dependent patent claims. It is to be noted that the description provides, in particular in conjunction with the figures, further details and developments of the disclosure which can be combined with the features from the patent claims.

This is promoted by an automated guided vehicle configured for driverless, autonomously acting operation for a load to be transported, comprising at least:
a control system which controls and steers the automated guided vehicle and
an evaluation unit which generates a signal for stopping the automated guided vehicle, wherein a detector device for detecting the arrangement of the load and/or of a lifting platform is connected to the control system, and wherein the automated guided vehicle is stopped automatically when the detected arrangement of the load deviates from a predefined arrangement of the load and/or as a result of an expected lowering of the lifting platform.

The automated guided vehicle presented here has, inter alia, the advantage that the load to be transported can rest freely on a lifting platform of the AGV after the loading process. The loss of the load during travel as a result of slipping on the lifting platform and/or as a result of unexpected lowering of the lifting platform is avoided in that the AGV is reliably stropped if such a situation is determined by means of a secure load sensor (Dolly Detection Sensor, DDS).

A driverless automated guided vehicle can be a power-driven vehicle, including any trailer, which is determined to move autonomously. For this purpose, the automated guided vehicle can interact with a guidance system in the floor or the surroundings which predefines the driving routes.

“Load” means here an object which is to be handled, including its mass, dimensions, state and/or arrangement. The load can be composed (only) of loading material. The load can also comprise the loading material and a transportation device for the loading material, e.g. a transportation wagon, pallet, a floor roller etc. “Load handling” which is executed by the automated guided vehicle can be understood to be, in particular, lifting, lowering, load transfer and/or load handling.

In particular, the driverless automated guided vehicle can be configured to move a dolly by means of a (possibly permanently installed) lifting platform. The automated guided vehicle can move, for example, partially under the dolly, pick up the dolly and lift it up somewhat above the floor, in particular in such a way that the dolly is no longer in (direct) contact with the floor when the automated guided vehicle moves. If the automated guided vehicle has reached its target position, the lifting platform can be lowered again and the dolly can be set down. The lifting platform is in particular designed and configured in such a way that it can be coupled to one or more predefined dollies. The automated guided vehicle can for example lift up the dolly by at least 10 centimeters, preferably by up to 20 centimeters, by means of the lifting platform, so that said dolly can also travel along gradients of up to 6% without the wheels of the dolly reaching the floor.

The control system contains an automatic device which controls (e.g. activates/deactivates) the automated guided vehicle and its associated devices and steers them (if appropriate with monitoring by sensor). The system of the driverless automated guided vehicle comprises the control system which can be part of the automated guided vehicle and/or separate therefrom. The control system can comprise a computing unit which is provided in or on the automated guided vehicle.

The evaluation unit can preferably be connected in an electrical and data-conducting fashion to a sensor system (e.g. of the detector device) and be configured to process the signals thereof. The evaluation unit is, in particular, configured to perform analysis of the data of the detector device so that the load can be sensed or determined unambiguously with respect to its position in the loading area or on the lifting platform of the automated guided vehicle. The position which is determined in the evaluation unit can be compared or influenced with predefined parameters (for example stored and/or set parameters), wherein a closed-control signal is then also transferred to the controller and in this context the operation of the automated guided vehicle can be influenced by the evaluation unit. The evaluation unit can be a separate (electronic) assembly, but it is also possible for the evaluation unit to be part of the actual control system for actuating the automated guided vehicle. The (at least) one data-conducting connection between the evaluation unit and the control apparatus and the sensor system can be implemented in a cable-bound or cableless fashion.

The detector device is configured to generate a signal which is representative of the loading state and/or a change in the loading state. The loading state and/or a change in the loading state can, in particular, also be sensed “indirectly” by virtue of the fact that a change in the position of the lifting platform is detected. This signal can be interpreted by the evaluation unit and bring about an instruction to the control system which can stop the automated guided vehicle by means of a brake system under the predefined operating conditions, in particular before the load or the dolly leaves the loading area (partially) and/or comes into contact with the floor. The detector device is also configured to generate, in the event of unexpected lowering of the lifting platform (in particular also while the automated guided vehicle is traveling), a signal to stop the automated guided vehicle. The detector device for detecting the arrangement of the load, in particular slipping of the load and/or positioning of the load, is connected to the evaluation unit and/or control device.

The detector device can in particular be configured to monitor an arrangement of the load, once it has been configured, sensed and/or predetermined, directly and/or indirectly on the basis of a state variable of the (activated) lifting platform, to store it and/or to compare it with a (stored) reference position. This can also be done by switching on the evaluation unit. When the expected or predefined arrangement of the load is deviated from and/or e.g. in the event of undesired lowering of the lifting platform, the stopping of the automated guided vehicle can be carried out automatically (immediately or without active intervention by persons) by means of the evaluation unit.

The control system preferably comprises a control unit for the desired direction of travel and the speed, a control unit for the motion and a control unit for the safety of the automated guided vehicle. A first control unit (robot control unit, RCU), a second control unit (motion control unit, MCU) and a third control unit (safety control unit, SCU) are preferably part of the control system.

The control system advantageously comprises at least one (data) memory which is protected against power failure, for (temporarily) storing the detected or sensed arrangement of the load and/or of the lifting platform. During the loading process, the state of the load and/or of the lifting platform can be stored in the memory which is protected against power failure. The data of the memory can ensure the monitoring of the load, at least over the entire transportation process, because said data is always available as reference data, in particular even after a brief power failure. The memory is preferably connected in such a way that the state of the load itself can be retrieved directly again when reactivation occurs after a power failure, and therefore resetting to an initial state is avoided and the transportation process can be automatically continued.

The memory is preferably a secure (in particular non-volatile) flip flop. A flip flop is an electronic circuit which has two stable electrical states and can be switched from one state into another by corresponding input signals.

The flip flop is expediently configured to store the arrangement of the load and/or of the lifting platform during the loading process and/or briefly after the loading process of the automated guided vehicle. This can be done, for example, by interrogation of the relevant sensors and switching of the flip flop in accordance with the interrogation results.

The flip flop is preferably configured to make the arrangement of the load and/or of the lifting platform available directly when reactivation occurs after a power failure, and/or to store said arrangement again and to continue the transportation process automatically.

The detector device advantageously comprises a lower lifting platform sensor and an upper lifting platform sensor. The lower lifting platform sensor can sense a lower (under certain circumstances inactive) position of the lifting platform. The upper lifting platform sensor can sense an upper (under certain circumstances active) position of the lifting platform. In this way, the position of the lifting platform can be determined unambiguously.

The lower lifting platform sensor and the upper lifting platform sensor are preferably connected to the third control unit (SCU).

A load sensor for detecting the arrangement of the load is expediently connected to the third control unit (SCU). It is also possible for the the signal of the load sensor to be used accumulatively or alternatively with respect to the signal of an upper lifting platform sensor.

The load sensor is preferably an inductive proximity sensor. Inductive proximity sensors operate with a magnetic field which is formed in front of the sensor in an open magnetic circuit. The approach of a (conductively) metallic object (such as e.g. the dolly) is based on attenuation of the magnetic field which can be sensed. The proximity sensor operates as contactless and can output a switching signal when the change in the magnetic field is detected.

The load sensor is advantageously arranged on the loading area of the automated guided vehicle.

The control system preferably comprises an evaluation unit. The evaluation unit is expediently integrated into the control system.

The loss of the load during travel as a result of slipping on the lifting platform or as a result of unexpected lowering of the lifting platform is avoided, in particular, by virtue of the fact that the automated guided vehicle is reliably stopped. During the loading process, the state of the load is preferably stored by means of a secure flip flop which ensures the monitoring of the load over the entire transportation process. Resetting of the flip flop does not occur until after the conclusion of the unloading process as a result of activation of the lower lifting platform sensor.

The loss of the load during travel as a result of unexpected lowering of the lifting platform due to a mechanical or electrical fault is avoided in that the AGV is reliably stopped if the lifting platform lowers unexpectedly (secure state of the upper lifting platform sensor). Controlled lowering of the lifting platform is not released after the picking up of a load until after safely monitored reverse travel into an unloading area.

In the case of a robot transportation vehicle, the state of the lifting platform and of the load are important safety aspects. Therefore, in the case of the automated guided vehicle presented here, a memory which is protected against power failure is provided for the loading state. Further advantageous features are the “use” of the memory (setting, resetting, fault logic, logic for actuating the lifting platform in accordance with the memory contents).

The automated guided vehicle can accordingly also be embodied with a system for data processing, comprising means for executing the steps of the method specified above, with the detector device. In particular, the system is configured to detect an arrangement of the load and/or of the lifting platform by means of the detector device, in particular using the evaluation unit, wherein
the evaluation unit detects a deviation of the arrangement of the load and/or lowering of the lifting platform, and
when a (predefinably) inadmissible deviation is detected, the (immediate) stopping of the travel of the automated guided vehicle is brought about.

By way of precaution it is to be noted that the designation of elements with numerical expressions (“first”, “second” . . . ) generally occurs only for the purpose of differentiation and does not have to specify a dependence or sequence of the elements. With regard to the sensors, this means, for example that their provision (in a stationary or simultaneously moving fashion) and/or location (on a carrier, gripper etc.) is freely selectable independently of the designation and in accordance with the technical conditions.

### BRIEF DESCRIPTION OF THE DRAWINGS

The disclosure and the technical environment are explained in more detail below with reference to figures. In this instance, identical components are characterized by identical reference symbols. The illustrations are provided schematically and not for illustrating size relationships. The explanations which are given with respect to individual details of a figure can be extracted and freely combined with contents from other figures or the description above, unless something else necessarily arises for a person skilled in the art or such a combination is explicitly prohibited. In the drawings:

FIG. 1 shows a plan view of a driverless, autonomously acting automated guidied vehicle with a control system and a detector device;

FIG. 2 shows a block diagram with the control system to which the detector device and a memory which is protected against power failure are connected;

FIG. 3 shows a side view of the automated guided vehicle according to FIG. 1 with loaded load and a sensor system;

FIG. 4 shows a circuit diagram for a first logic circuit; and

FIG. 5 shows a circuit diagram for a second logic circuit.

### DETAILED DESCRIPTION

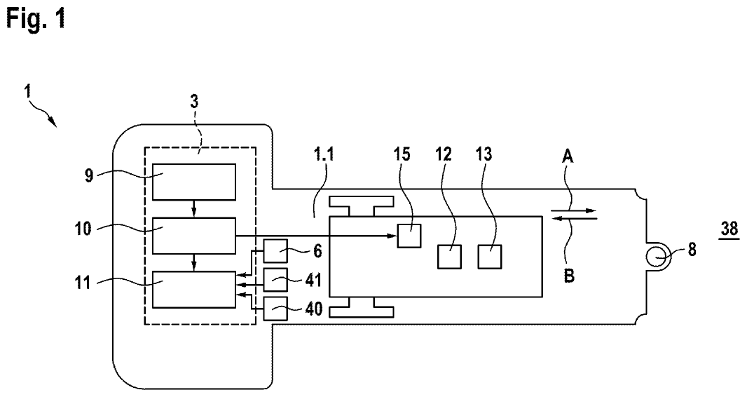

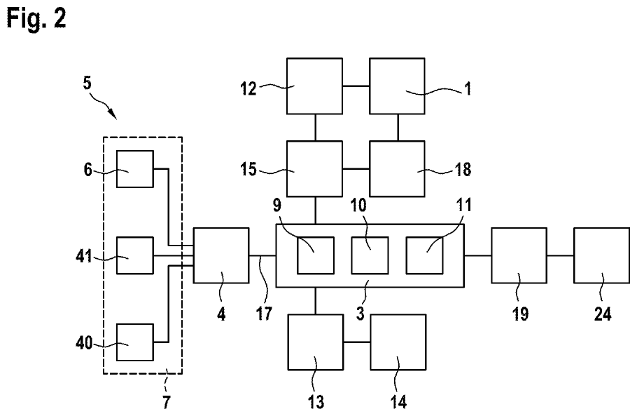

FIG. 1 shows a plan view of a driverless, autonomously acting automated guided vehicle 1 with a control system 3 and a detector device 5 (see FIG. 2).

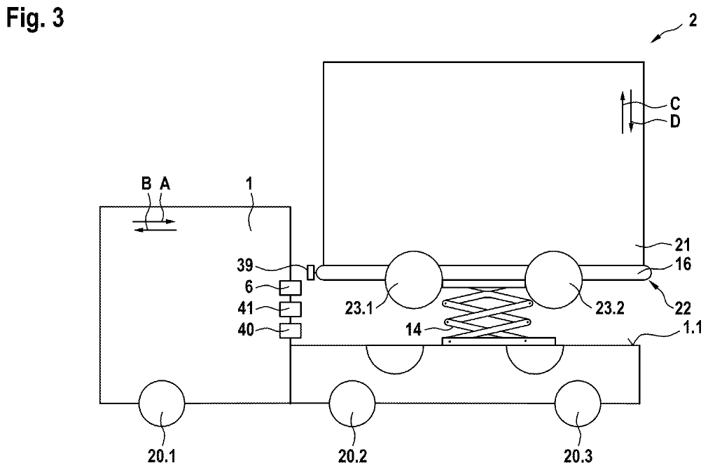

The automated guided vehicle 1 which is presented here and is loaded with a load 2 (see FIG. 3) comprises at least the control system 3, which controls and steers the automated guided vehicle 1, and an evaluation unit 4 (see FIG. 2) which generates a signal for stopping the automated guided vehicle 1. The detector device 5 (see FIG. 2) comprises a load sensor 6 for detecting the arrangement of the load 2 and a lower lifting platform sensor 40 and an upper lifting platform sensor 41 for detecting undesired lowering of the lifting platform 16 of a lifting and lowering device 14 (see FIG. 3). The control system 3 comprises a first control unit 9 for the desired direction of travel and the speed, a second control unit 10 for the motion, and a third control unit 11 for the safety of the automated guided vehicle 1. In the specific application, two first motors 12 are present for the travel motion of the automated guided vehicle 1, both are equipped with a secure rotational speed encoder 15 (“SIL2” denotes a safety level and can also be SIL1 or 3 depending on the requirement). A further motor 13 serves to move the lifting and lowering device 14 (the lifting platform) and is monitored by inductive sensing of the loading area position (without a rotary encoder). A laser scanner 8 which monitors an unloading area 38 and the load 2 is arranged at the rear end of the automated guided vehicle 1.

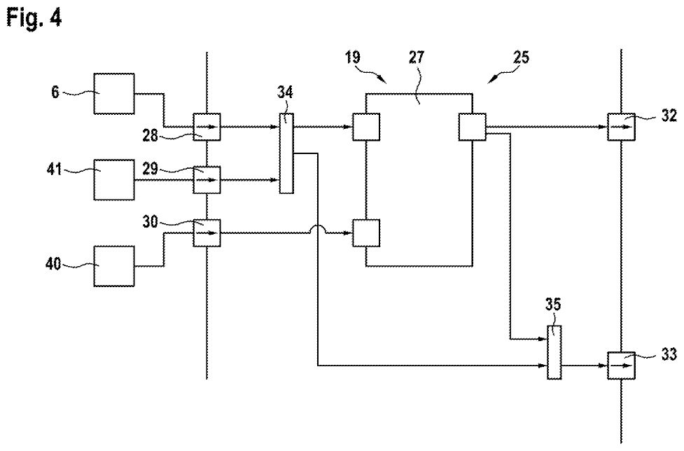

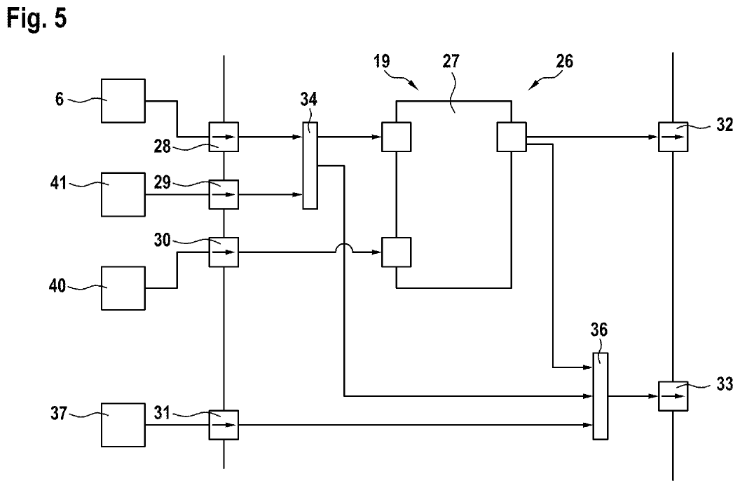

FIG. 2 illustrates a block circuit diagram with the control system 3 to which the detector device 5 is connected. The lower lifting platform sensor 40, the upper lifting platform sensor 41 and the load sensor 6 are connected to the electronic control system 3 by a data-conducting connection 17. The second control unit 10 is connected via rotary encoder 15 (setpoint rotational speed) to two first motors 12 for the vehicle motion. A brake system 18 is connected to the control system 3 which can generate a signal to the first motors 12 for stopping the automated guided vehicle 1. The brake system 18 can also act alone, or in combination with the first motors 12, on the automated guided vehicle 1. Furthermore, a second motor 13 for driving the lifting and lowering device 14 is connected to the control system 3. 19 denotes a flip flop 27 (see FIGS. 4 and 5) as a memory which is protected against power failure and is connected to the controller 3. A battery 18 is connected to the flip flop 27, in order to retain the program in the memory 19 during a power failure.

FIG. 3 shows a side view of the automated guided vehicle 1 according to FIG. 1 with a loaded load 2. An inductive proximity sensor, e.g. a sensor with an inherent safety function, is present as the load sensor 6. The load sensor 6 is arranged on the rear side of the loading area 1.1 of the automated guided vehicle 1 and is oriented in the direction of the load 2. The load 2 is composed here of loading material 21 and a dolly 22, with which the loading material 21 can be transported. Wheels of the automated guided vehicle 1 are denoted by 20.1, 20.2 and 20.3. Wheels of the dolly 22 are denoted by 23.1 and 23.2. The lifting and lowering device 14 is installed in the form of a scissor-type lifting unit, at the upper end of which there is a lifting platform 16, on the loading area 1.1 of the automated guided vehicle 1. The lifting platform 16 supports the dolly 22 with the loading material 21. The directions of movement of the lifting and lowering device 14, of the lifting platform 16, of the dolly 22 and of the loading material 21 in the vertical direction are denoted by C and D. Furthermore, the lower lifting platform sensor 40 and the upper lifting platform sensor 41 are mounted one on top of the other on the rear side of the loading area 1.1 and are oriented in the direction of the lifting platform 16. A (conductive) iron element 39, e.g. a screw, is attached to the lifting platform 16 and interacts with the inductive lifting platform sensors 40 and 41 and with the load sensor 6 and can be sensed by them by means of measuring technology.

FIG. 4 shows a circuit diagram for a first embodiment of a logic circuit 25. The load sensor 6, the upper lifting platform sensor 41 and the lower lifting platform sensor 40 are connected to a first input 28, a second input 29 and respectively a third input 30. The inputs 28 and 29 lead to a first AND gate 34, downstream of which a flip flop 27 and a second AND gate 35 are arranged. The third input 30 is connected to the flip flop 27. A first output 32 and the second AND gate 35 are arranged downstream of the flip flop 27. A second output 33 is arranged downstream of the second AND gate 35. The basic sequencing logic for this can be summarized, for example, as follows:
1. The first control unit 9 transmits the desired direction of travel and the speed to the second control unit 10.
2. The second control unit 10 passes on the desired direction of travel to the third control unit 11, calculates the setpoint rotational speeds and transmits them to the motors.
3. The third control unit 11 detects by means of the load sensor 6 (logic 1) and the upper lifting platform sensor 41 (logic 1) that a load 2 has been loaded on, and it stores this state in a secure flip flop 27.
4. If the load 2 slips during the transportation travel (load sensor=logic 0), the third control unit 11 sets the speed to v=0 mm/s by means of the second control unit 10. (The setpoint speeds of the third control unit 11 have priority over the desired speeds of the first control unit 9.)
5. The third control unit 11 detects the unloading of the load 2 by means of the lower lifting platform sensor 40 (logic 1) and resets the flip flop 27.

FIG. 5 illustrates a circuit diagram of a second embodiment of a logic circuit 26. The logic circuit 26 corresponds largely to the logic circuit 25 according to FIG. 4, but with the difference that a resetting element 37 is connected to a fourth input 31, downstream of which a third AND gate 36 is arranged. The basic sequencing logic for this can be summarized, for example, as follows:
1 The first control unit 9 transmits the desired direction of travel and the speed to the second control unit 10.
2. The second control unit 10 passes on the desired direction of travel to the third control unit 11, calculates the setpoint rotational speed and transmits it to the motors.
3. The third control unit 11 detects by means of the load sensor 6 (logic 1) and the upper lifting platform sensor 41 (logic 1) that a load 2 has been loaded on and stores this state in a secure flip flop 27.
4. If the lifting platform 16 unexpectedly lowers during the transportation travel (logic 0), the third control unit 11 sets the speed to v=0 mm/s via the second control unit 10. (The setpoint speeds of the third control unit 11 have priority over the desired speeds of the first control unit 9.)
5. Controlled lowering is released after a safely monitored reverse travel e.g. by means of a laser scanner 8, into an unloading area 38 (see FIG. 1) (unload=logic 1).

The driverless, autonomously acting automated guided vehicle 1 (AGV) presented here is preferably used, for example, in factories, warehouses, supermarkets or hospitals. Colllisions (in particular with a person and/or an object) and/or disorientation are avoided by means of sensors, for example laser scanners, inductive proximity sensors, ultrasonic sensors and/or 3D cameras. For example pallets, crates, shelves, individual parts or small load carriers (SLCs) with or without dollies are transported.

### LIST OF REFERENCE SYMBOLS

1 Automated guided vehicle
1.1 Loading area
2 Load
3 Control system
4 Evaluation unit
5 Detector device
6 Load sensor
7 Sensor System
8 Laser scanner
9 First control unit
10 Second control unit
11 Third control unit
12 First motor
13 Second motor
14 Lifting and lowering device
15 Rotary encoder
16 Lifting platform
17 Data-conducting connection
18 Brake system
19 Memory
20.1,20.2,20.3 Wheels of automated guided vehicle
21 Loading material
22 Dolly
23.1,23.2 Wheels of dolly
24 Battery
25 First logic circuit
26 Second logic circuit
27 Flip flop
28 First input
29 Second input
30 Third input
31 Fourth input
32 First output
33 Second output
34 First AND gate
35 Second AND gate
36 Third AND gate
37 Resetting element
38 Unloading area
39 Iron element
40 Lower lifting platform sensor
41 Upper lifting platform sensor
A,B,C,D Directions of movement

What is claimed is:

1. An automated guided vehicle for driverless, autonomously acting operation for a load to be transported, comprising:
a control system configured to control and to steer the automated guided vehicle;
an evaluation unit configured to generate a signal for stopping the automated guided vehicle; and
a detector device operably connected to the control system and configured to detect an arrangement of the load and/or of a lifting platform,
wherein the automated guided vehicle is stopped automatically when the detected arrangement of the load deviates from a predefined arrangement of the load and/or as a result of an expected lowering of the lifting platform.

2. The automated guided vehicle according to claim 1, wherein the control system comprises a first control unit configured to control a desired direction of travel and a speed of the automated guided vehicle, a second control unit configured to control a motion of the automated guided vehicle, and a third control unit configured to control safety of the automated guided vehicle.

3. The automated guided vehicle according to claim 1, wherein the control system comprises at least one memory protected against power failure and configured to store the detected arrangement of the load and/or of the lifting platform.

4. The automated guided vehicle according to claim 3, wherein the memory is a flip flop.

5. The automated guided vehicle according to claim 4, wherein the flip flop is configured to store the detected arrangement of the load and/or of the lifting platform during a loading process of the automated guided vehicle.

6. The automated guided vehicle according to claim 4, wherein the flip flop is configured, when re-activation occurs after a power failure, to directly store again the detected arrangement of the load and/or of the lifting platform and to continue a transportation process automatically.

7. The automated guided vehicle according to claim 2, wherein the detector device comprises a lower lifting platform sensor and an upper lifting platform sensor.

8. The automated guided vehicle according to claim 7, wherein the lower lifting platform sensor and the upper lifting platform sensor are connected to the third control unit.

9. The automated guided vehicle according to claim 1, wherein:
the detector device includes a load sensor configured to detect the arrangement of the load, and
the load sensor includes an inductive proximity sensor.

10. The automated guided vehicle according to claim 1, wherein the evaluation unit is integrated into the control system.
